(19) United States
(12) Patent Application Publication
(10) Pub. No.: US 2005/0067732 A1
(43) Pub. Date: Mar. 31, 2005

(54) Manufacturing device and the method of preparing for the nanofibers via electro-blown spinning process

(76) Inventors: Yong Min Kim, Koyang City (KR); Kyoung Ryoul Ahn, Ansan City (KR); Young Bin Sung, Ansan City (KR); Rai Sang Jang, Ansan City (KR)

Correspondence Address: Law Office of Royal W Craig, Suite 153, 10 North Calvert Street, Baltimore, MD, 21202, US

(21) Appl. No.: 10/477,882

(22) PCT Filed: Nov. 20, 2002
(86) PCT No.: PCT/KR02/02165

(30) Foreign Application Priority Data
Mar. 26, 2002 (KR) 2002-16489

(51) Int. Cl. B32B 31/08

(52) U.S. Cl. 264/172.19

(57) ABSTRACT

The invention relates to a nanofiber web preparing apparatus and method via an electro-blown spinning. The nanofiber web preparing method comprises: feeding a polymer solution, which is dissolved into a given solvent, toward a spinning nozzle; discharging the polymer solution via the spinning nozzle, which is applied with a high voltage, while injecting compressed air via the lower end of the spinning nozzle; and collecting fiber spun in the form of a web on a grounded suction collector under the spinning nozzle, in which both of thermoplastic and thermosetting resins are applicable, solution doesn't need to be heated and insulation is readily realized.

### TECHNICAL FIELD

The present invention relates to a nanofiber web preparing apparatus and method via an electro-blown spinning, in particular, in which both of thermoplastic and thermosetting resins are applicable, solution doesn't need to be heated and insulation is readily realized. Herein, “electro-blown” means injecting compressed air while applying a high voltage during spinning of nanofiber, and “electro-blown spinning” means spinning using an electro-blown method.

### BACKGROUND ART

In general, consumption of non-woven cloth is gradually increasing owing to various applications of non-woven cloth, and manufacturing processes of non-woven cloth are also variously developing.

A variety of studies have been carried out in many countries including the USA for developing technologies for manufacturing non-woven cloth composed of ultra-fine nanofiber (hereinafter it will be referred to as ‘nanofiber web’) which is advanced for one stage over conventional super-fine fiber. Such technologies are still in their initial stage without any commercialization while conventional technologies remain in a stage in which super-fine fibers are prepared with a diameter of about several micrometer. Nanofiber having a diameter of about several nanometer to hundreds of nanometer cannot be prepared according to conventional super-fine fiber technologies. Nanofiber has a surface area per unit volume, which is incomparably larger than that of conventional super-fine fiber. Nanofiber having various surface characteristics, structures and combined components can be prepared so as to overcome limit physical properties of articles made of conventional super-fine fiber while creating articles having new performance.

It is well known that a nanofiber web using the above nanofiber preparing method is possibly applied as an ultra precise filter, electric-electronic industrial material, medical biomaterial, high-performance composite, etc.

The technologies in use for preparing ultra-fine fiber up to the present can be classified into three methods including flash spinning, electrostatic spinning and melt-blown spinning. Such technologies are disclosed in Korean Laid-Open Patent Application Serial Nos. 10-2001-31586 and 10-2001-31587, entitled “Preparing Method of Ultra-Fine Single Fiber” previously filed by the assignee.

In the meantime, Korean Laid-Open Patent Application Serial No. 10-2001-31586 discloses that nanofiber in nanometer scale can be mass-produced with high productivity and yield by systematically combining the melt-blown spinning and the electrostatic spinning. FIG. 5 schematically shows a process for explaining this technology. Referring to FIG. 5, a thermoplastic polymer is fed via a hopper into an extruder 12 where the thermoplastic polymer is melted into a liquid polymer. The molten liquid polymer is fed into a spinnerette 14 and then spun via a spinning nozzle 16 together with hot air into an electric field. The electric field is generated between the spinning nozzle 16 applied with voltage and a collector 18. Monofibers spun onto the collector 18 are collected in the form of a web by a sucking blower 20.

Also Korean Laid-Open Patent Application Serial No. 10-2001-31587 discloses that nanofiber in nanometer scale can be mass-produced with high productivity and yield by systematically combining the flash spinning and the electrostatic spinning. FIG. 6 schematically shows a process for explaining this technology. Referring to FIG. 6, a polymer solution is fed from a storage tank 22 into a spinnerette 26 with a compression pump 24, and spun into an electric field via a decompressing orifice 28 and then via a spinning nozzle 30. The electric field is generated between the spinning nozzle 30 applied with voltage and a collector 32. Monofibers spun onto the collector 32 are collected in the form of a web by a sucking blower 34.

It can be understood that the nanofiber webs composed of nanofiber can be prepared according to the two technologies as above.

However, the foregoing conventional technologies have many drawbacks in that insulation is not readily realized, applicable resin is restricted and heating is needed.

### DISCLOSURE OF INVENTION

The present invention has been made to solve the foregoing problems and it is therefore an object of the present invention to provide a nanofiber web preparing method in which both of thermoplastic and thermosetting resins are applicable, solution doesn't need to be heated and insulation is readily realized.

It is another object of the invention to provide a nanofiber web preparing apparatus for realizing the above preparing method.

According to an aspect of the invention to obtain the above objects, it is provided a nanofiber web preparing method comprising the following steps of: feeding a polymer solution, which is dissolved into a given solvent, to a spinning nozzle; discharging the polymer solution via the spinning nozzle, which is applied with a high voltage, while injecting compressed air via the lower end of the spinning nozzle; and collecting fiber spun in the form of a web on a grounded suction collector under the spinning nozzle.

According to another aspect of the invention to obtain the above objects, it is provided a nanofiber web preparing apparatus comprising: a storage tank for preparing a polymer solution; a spinning nozzle for discharging the polymer solution fed from the storage tank; an air nozzle disposed adjacent to the lower end of the spinning nozzle for injecting compressed air; means for applying high voltage to the spinning nozzle; and a grounded collector for collecting spun fiber in the form of a web which is discharged from the spinning nozzle.

### BRIEF DESCRIPTION OF THE DRAWINGS

FIG. 1 shows a construction of a nanofiber web preparing apparatus of the invention;

FIG. 2A is a sectional view of a spinnerette having an air nozzle on a knife edge;

FIG. 2B is a sectional view of another spinnerette having a cylindrical air nozzle;

FIG. 3 schematically shows a nanofiber preparing process via systematic combination of a melt-blown spinning and an electro-blown spinning; and

FIG. 4 schematically shows a nanofiber preparing process via systematic combination of a flash spinning and an electrostatic spinning.

### BEST MODE FOR CARRYING OUT THE INVENTION

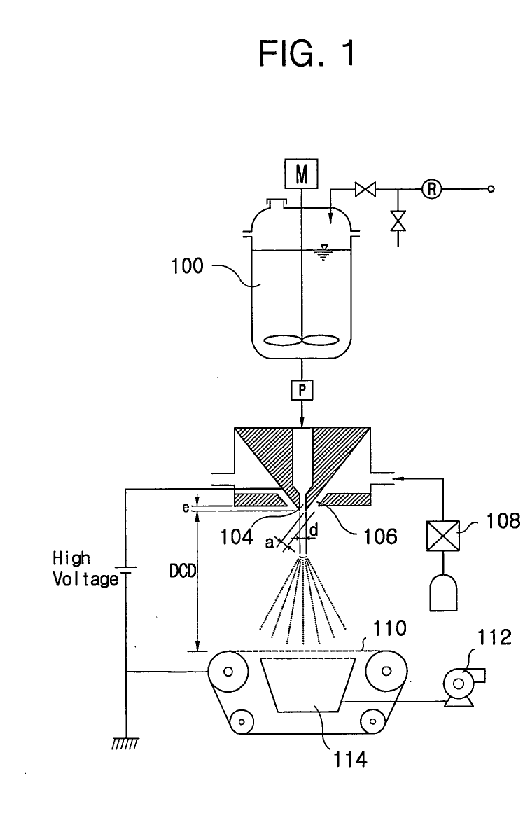

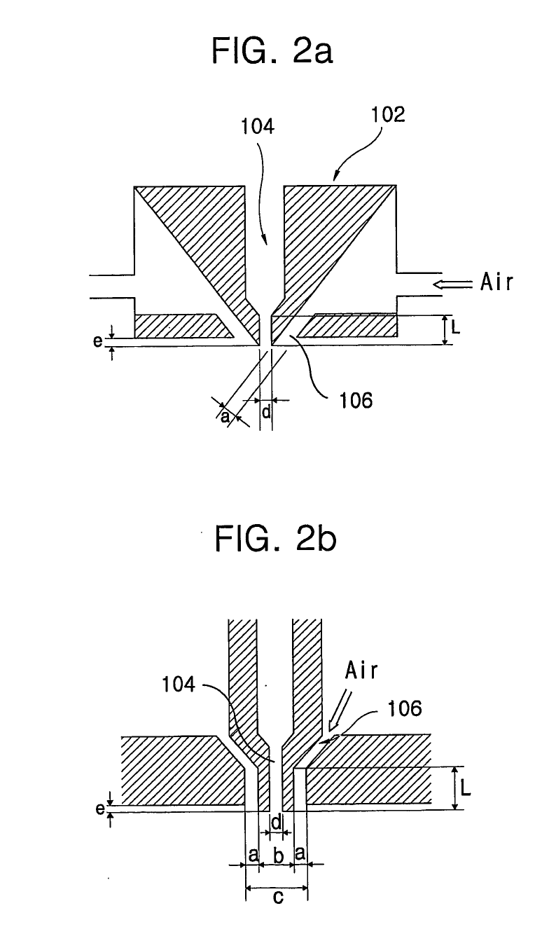

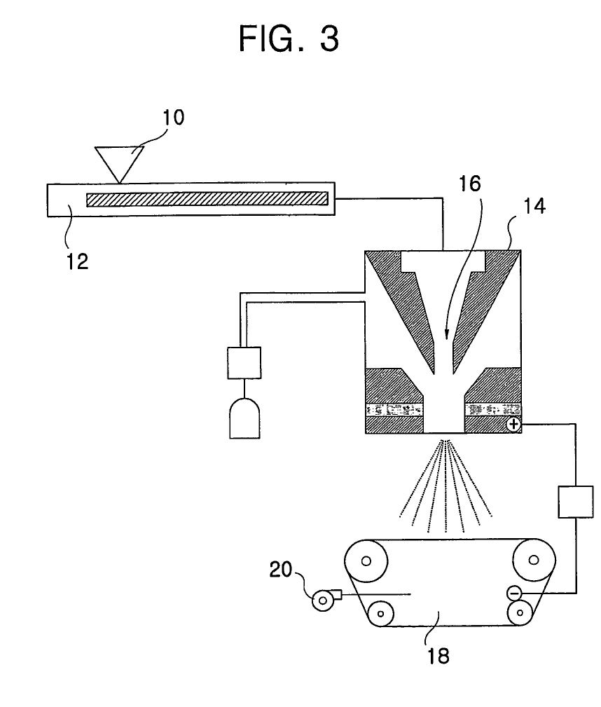

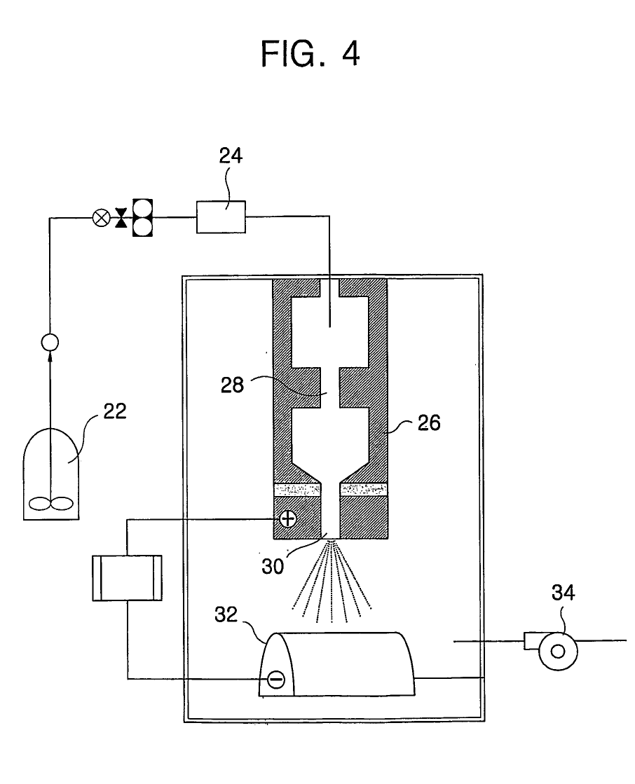

FIG. 1 shows a construction of a nanofiber web preparing apparatus of the invention for illustrating a nonofiber web preparing process, and FIGS. 2A and 2B show nozzle constructions for illustrating spinning nozzles and air nozzles. The nonofiber web preparing process will be described in detail in reference to FIGS. 1 to 2B.

A storage tank 100 prepares a polymer solution via composition between polymer and solvent. Polymers available for the invention are not restricted to thermoplastic resin, but may utilize most synthetic resin such as thermosetting resin. Examples of the available polymers may include polyimide, nylon, polyaramide, polybenzimidazole, polyetherimide, polyacrylonitrile, PET (polyethylene terephthalate), polypropylene, polyaniline, polyethylene oxide, PEN (polyethylene naphthalate), PBT (polybutylene terephthalate), SBR (styrene butadiene rubber), polystyrene, PVC (polyvinyl chloride), polyvinyl alcohol, PVEDF (polyvinylidene chloride), polyvinyl butylene and copolymer or derivative compound thereof. The polymer solution is prepared by selecting a solvent according to the above polymers. Although the apparatus shown in FIG. 1 adopts a compression arrangement which forcibly blows compressed air or nitrogen gas into the storage tank 100 in order to feed the polymer solution from the storage tank 100, any known means can be utilized without restricting feed of the polymer solution. The polymer solution can be mixed with additives including any resin compatible with an associated polymer, plasticizer, ultraviolet ray stabilizer, crosslink agent, curing agent, reaction initiator and etc. Although dissolving most of the polymers may not require any specific temperature ranges, heating may be needed for assisting dissolution reaction.

The polymer solution is discharged from the storage tank 100 via a spinning nozzle 104 of a spinnerette 102 which is electrically insulated and applied with a high-voltage. After heated in an air heater 108, compressed air is injected via air nozzles 106 disposed in sides of the spinning nozzle 104.

Now reference will be made to FIGS. 2A and 2B each illustrating the construction of the spinning nozzle 104 and the air nozzle 106 in the spinnerette 102. FIG. 2A shows the same construction as in FIG. 1 in which the air nozzle 106 is disposed on a knife edge at both sides of the spinning nozzle 104. In the spinning nozzle 104 shown in FIG. 2A, the polymer solution flows into the spinning nozzle 104 through an upper portion thereof and is injected past a capillary tube in the lower end. Since a number of spinning nozzles 104 of the above construction are arranged in a line for a given interval while a number of air nozzles 106 may be arranged on knife edges at both sides of the spinning nozzles 104 parallel to the arrangement thereof, nanofiber can be advantageously spun with the number of spinning nozzles 104. Referring to preferred magnitudes of the components, the air nozzles 106 each have an air gap a which is availably sized in the range of about 0.1 to 5 mm and preferably of about 0.5 to 2 mm, whereas the lower end capillary tube has a diameter d which is an availably sized with in the range of about 0.1 to 2.0 mm and preferably of about 0.2 to 0.5 mm. The lower end capillary tube of the air nozzle 106 has an available length-to-diameter ratio L/d, which is in the range of about 1 to 20 and preferably about 2 to 10. A nozzle projection e has a length corresponding to the difference between the lower end of an air nozzle 106 and the lower end of a spinning nozzle 104, and functions to prevention pollution of the spinning nozzle 104. The length of the nozzle projection e is preferably about −5 to 10 mm, and more particularly 0 to 10 mm.

The spinning nozzle 104 shown in FIG. 2B has a construction which is substantially equivalent to that shown in FIG. 2A while the air nozzle 106 has a cylindrical structure circularly surrounding the spinning nozzle 104, in which compressed air is uniformly injected from the air nozzle 106 around nanofiber, which is spun through the spinning nozzle 104, so as to have an advantageous orientation over the construction of FIG. 2A, i.e. the air nozzles on the knife edge. Where a number of spinning nozzles 104 are necessary, spinning nozzles 104 and air nozzles 106 of the above construction are arranged in the spinnerette. However, a manufacturing process of this arrangement requires more endeavors over that in FIG. 2A.

Now referring to FIG. 1 again, the polymer solution discharged from the spinning nozzle 104 of the spinnerette 102 is collected in the form of a web on a suction collector 110 under the spinning nozzle 104. The collector 110 is grounded, and designed to suck air through an air collecting tube 114 so that air can be sucked in through a high voltage between the spinner nozzle 104 and the collector 110 and suction of a blower 112. Air sucked in by the blower contains solvent and thus a Solvent Recovery System (SRS, not shown) is preferably designed to recover solvent while recycling air through the same. The SRS may adopt a well-known construction.

In the above construction for the preparing process, portions to which voltage is applied or which is grounded are apparently divided from other portions so that insulation is readily realized.

The invention injects compressed air through the air nozzle 106 while sucking air through the collector 110 so that nozzle pollution can be minimized as the optimum advantage of the invention. As not apparently described in the above, nozzle pollution acts as a severe obstructive factor in preparation processes via spinning except for the melt-blown spinning. The invention can minimize nozzle pollution via compressed air injection and suction. The nozzle projection e more preferably functions to clean nozzle pollution since compressed air injected owing to adjustment of the nozzle projection e can clean the nozzles.

Further, a certain form of substrate can be arranged on the collector to collect and combine a fiber web spun on the substrate so that the combined fiber web is used as a high-performance filter, wiper and so on. Examples of the substrate may include various non-woven cloths such as melt-blown non-woven cloth, needle punching and spunlace non-woven cloth, woven cloth, knitted cloth, paper and the like, and can be used without limitations so long as a nanofiber layer can be added on the substrate.

The invention has the following process conditions.

Voltage applied to the spinnerette 102 is preferably in the range of about 1 to 300 kV and more preferably of about 10 to 100 kV. The polymer solution can be discharged in a pressure ranging from about 0.01 to 200 kg/cm2 and in preferably about 0.1 to 20 kg/cm2. This allows the polymer solution to be discharged by a large quantity in an adequate manner for mass production. The process of the invention can discharge the polymer solution with a high discharge rate of about 0.1 to 5 cc/rnin-hole as compared with electrostatic spinning methods.

Compressed air injected via the air nozzle 106 has a flow rate of about 10 to 10,000 m/min and preferably of about 100 to 3,000 m/min. Air temperature is preferably in the range of about 300° C. and more preferably of about 100° C. at a room temperature. A Die to Collector Distance (DCD), i.e. the distance between the lower end of the spinning nozzle 104 and the suction collector 110, is preferably about 1 to 200 cm and more preferably 10 to 50 cm.

Hereinafter the present invention will be described in more detail in the following examples.

A polymer solution having a concentration of 20 W % was prepared using polyacronitrile (PAN) as a polymer and DMF as a solvent and then spun with the spinnerette on the knife edge as shown in FIG. 1. The polymer solution was spun according to the following condition, in which a spinning nozzle had a diameter of about 0.25 mm, L/d of the nozzle was 10, LCD was 200 mm, a spinning pressure was 6 kg/cm2 and an applied pressure was DC 50 kV.

The spinnerette on the knife edge constructed as in FIG. 1 was used in the following examples. The diameter of the spinning nozzle was 0.25 mm, L/d of the nozzle was 10, and DCD was varied in examples 1 to 3 and set to 300 mm in examples 4 to 10. The number of the spinning nozzles was 500, the width of a die was 750 mm, the nozzle projection e was about 0 to 3 mm, and the flow rate of compressed air was maintained at 300 to 3,000 m/min in the air nozzle.

TABLE 1

| | | | | | Spinning | App. |
|---|---|---|---|---|---|---|
| | | | | DCD | Pressure | Voltage |
| No | Polymer | Solvent | Conc. (%) | (mm) | (kgf/cm2) | (kV) |
| Ex. 1 | PAN | DMF | 15 | 350 | 3 | 30 |
| Ex. 2 | PAN | DMF | 20 | 160 | 4 | 40 |
| Ex. 3 | PAN | DMF | 20 | 200 | 6 | 50 |
| Comp. | PAN | DMF | 25 | | | |
| Ex. 4 | | | | | | |

Example 1 was good in fluidity and spinning ability, but poor in formation of web. Examples 2 and 3 were good in fluidity, spinning ability and formation of web. Examination of SEM pictures showed diameter distribution of about 500 nm to 2 μm. In particular, it can be seen in example 3 that uniform diameter distribution was in the range of 500 nm to 1.2 μm. In comparative example 1, it was difficult to prepare a PAN 25% solution and thus any result was not obtained.

TABLE 2

| | Spinning Pressure | | Diam. Distribution |
|---|---|---|---|
| No | (kgf/cm²) | App. Voltage (kV) | (nm) |
| Ex. 4 | 3 | 21 | 933.96-1470 |
| Ex. 5 | 3 | 30 | 588.69-1000 |
| Ex. 6 | 2.9 | 40 | 500.9-970.8 |
| Ex. 7 | 3 | 60 | 397.97-520.85 |
| Ex. 8 | 3.1 | 80 | 280.01-831.60 |
| Ex. 9 | 3.5 | 40 | 588.69-933.77 |
| Ex. 10 | 4 | 40 | 633.9-1510 |

Table 2 reports conditions and their results of examples 4 to 10, which used nylon 66 for polymer, formic acid for solvent. Polymer solution had a concentration of 25%. Diameter distributions in Table 2 are result of SEM picture examination, in which nanofibers having a uniform diameter are irregularly arranged in the form of a web.

Industrial Applicability

As set forth above, the present invention allows the web to be composed of nanofiber with a fiber fineness ranging from about several nanometer to hundreds of nanometer. Also the preparing process of the invention has a higher discharge rate over the conventional electrostatic spinning thereby potentially mass producing nanofiber. Further, since the polymer solution is used, the invention has advantages in that the necessity of heating polymer is reduced and both thermoplastic and thermosetting resins can be used.

Moreover, in the arrangement used for the electro-blown spinning, the spinnerette can be readily insulated while solvent can be recovered via suction.

1. A nanofiber web preparing method comprising the following steps of:
feeding a polymer solution, which is dissolved into a given solvent, to a spinning nozzle;
discharging the polymer solution via the spinning nozzle, which is applied with a high voltage, while injecting compressed air via the lower end of the spinning nozzle; and
spinning the polymer solution on a grounded suction collector under the spinning nozzle.

2. The nanofiber web preparing method as claimed in claim 1, wherein the high voltage applied to the spinning nozzle is about 1 to 300 kV.

3. The nanofiber web preparing method as claimed in claim 1, wherein the polymer solution is compressively discharged through the spinning nozzle under a discharge pressure in the range of about 0.01 to 200 kg/cm².

4. The nanofiber web preparing method as claimed in claim 1, wherein the compressed air has a flow rate of about 10 to 10,000 m/min and a temperature of about room temperature to 300° C.

5. The nanofiber web preparing method as claimed in claim 4, wherein the compressed air has a temperature ranging from a room temperature to 300° C.

6. The nanofiber web preparing method as claimed in claim 1, further comprising the step of collecting fiber in the form of a web from the polymer solution spun on the collector.

7. The nanofiber web preparing method as claimed in claim 1, wherein the collector has a substrate disposed thereon for collecting the fiber spun in the form of a web on the substrate.

8. The nanofiber web preparing method as claimed in claim 1, wherein the polymer is one selected from a group including polyimide, nylon, polyaramide, polybenzimidazole, polyetherimide, polyacrylonitrile, PET (polyethylene terephthalate), polypropylene, polyaniline, polyethylene oxide, PEN (polyethylene naphthalate), PBT (polybutylene terephthalate), SBR (styrene butadiene rubber), polystyrene, PVC (polyvinyl chloride), polyvinyl alcohol, PVEDF (polyvinylidene chloride), polyvinyl butylene and copolymer or derivative compound thereof.

9. A nanofiber web preparing apparatus for preparing a nanofiber web the apparatus comprising:
a storage tank for preparing a polymer solution;
a spinning nozzle for discharging the polymer solution fed from the storage tank;
an air nozzle disposed adjacent to the lower end of the spinning nozzle for injecting compressed air;
means for applying high voltage to the spinning nozzle; and
a grounded collector for collecting spun fiber in the form of a web which is discharged from the spinning nozzle.

10. The nanofiber web preparing apparatus as claimed in claim 9, further comprising a capillary tube in a lower portion of the spinning nozzle, wherein the capillary tube has a diameter of about 0.1 to 2.0 mm and a ratio of length to diameter of about 1 to 20.

11. The nanofiber web preparing apparatus as claimed in claim 9, wherein the air nozzle for injecting compressed air is disposed on a knife edge at both sides of the spinning nozzle, and has a distance or air gap of about 0.1 to 5.0 mm.

12. The nanofiber web preparing apparatus as claimed in claim 9, wherein the air nozzle has a cylindrical shape for circularly surrounding the spinning nozzle and a width or air gap of about 0.1 to 5.0 mm.

13. The nanofiber web preparing apparatus as claimed in claim 9, the lower end of the spinning nozzle is spaced from the collector for about 1 to 200 cm.

14. The nanofiber web preparing apparatus as claimed in claim 9, further comprising a blower for sucking air from a spinning space into the collector, wherein the blower feeds air into a solvent recovery system for recovering solvent.

15. The nanofiber web preparing apparatus as claimed in claim 9, wherein a nozzle projection corresponds to a height difference between the lower end of the air nozzle and the lower end of the spinning nozzle, the nozzle projection being −5 to 10 mm.

16. The nanofiber web preparing apparatus as claimed in claim 9, further comprising a pump for feeding the polymer solution from the storage tank to the spinning nozzle.
